(19) United States
(12) Patent Application Publication
(10) Pub. No.: US 2014/0366124 A1
(43) Pub. Date: Dec. 11, 2014

(54) DETERMINATION DEVICE, DETERMINATION METHOD AND DETERMINATION PROGRAM

(71) Applicants: Yozo Takehara, Kawagoe-shi (JP); Yuusuke Takano, Kawagoe-shi (JP); Shunichiro Nagao, Kawagoe-shi (JP)

(72) Inventors: Yozo Takehara, Kawagoe-shi (JP); Yuusuke Takano, Kawagoe-shi (JP); Shunichiro Nagao, Kawagoe-shi (JP)

(73) Assignee: PIONEER CORPORATION, Kawasaki-shi ,Kanagawa (JP)

(21) Appl. No.: 14/368,075

(22) PCT Filed: Dec. 22, 2011
(86) PCT No.: PCT/JP2011/079904

§ 371 Date: Jun. 23, 2014

(51) Int. Cl. G06F 21/36; G06F 3/041

(52) U.S. Cl. CPC G06F 21/36; G06F 3/0416
USPC 726/16

(57) ABSTRACT

The determination device displays a target image specifying a random position on a screen, and obtains a designated position by the user for the target image. Then, the determination device determines whether or not the designated position coincides with the position of the target image. When a number of times determined to coincide reaches a predetermined necessary number of coincidence, the determination device determines that the authentication is successful.

### TECHNICAL FIELD

The present invention relates to a technique for determining whether or not an equipment is being operated by a human being.

### BACKGROUND TECHNIQUE

Recently, there are many websites on the Internet which execute authentication based on an input by a user. As an authentication method of this kind, there is known an authentication method using “CAPTCHA” (Registered Trademark) which presents an image formed by deforming characters to the user and requests the user to input the character string thus presented, thereby to prevent an automatic analysis by a computer. This aims to determine that the operator is a human being.

Patent Reference 1 discloses an authentication method which makes the reading by a “bot”, having a function of recognizing the characters included in the image, difficult thereby to improve security.

Patent Reference 1: Japanese Patent Application Laid-Open under No. 2008-262549

### DISCLOSURE OF INVENTION

### Problem to be Solved by the Invention

While the technique of Patent Reference 1 makes the reading by the bot difficult, the user needs to read the characters and/or marks embedded in an obscure image and input them, making the operation troublesome. Particularly, such an operation is difficult for an old person and/or a child.

The above is an example of the problems to be solved by the present invention. It is an object of the present invention to provide an input determination method capable of determining that the operator is a human being, with an easy operation and with making the reading by the bot difficult.

### Means for Solving the Problem

One invention is a determination device comprising: an image control unit which displays, on a screen, (i) a target image arbitrarily specifying a position on the screen in order with arbitrarily changing the position on the screen, or (ii) a plurality of target images arbitrarily specifying the positions on the screen at a same time; an obtaining unit which obtains a designated position designated on the screen; and a determination unit which determines whether or not the positions of the target images displayed on the screen are designated in a predetermined order.

Another invention is a determination device connected to a terminal device via a network, comprising: an image control unit which transmits, via the network, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining unit which obtains, via the network, a designated position designated on the screen of the terminal device; and a determination unit which determines whether or not the positions of the target images displayed on the screen are designated in a predetermined order.

Still another invention is a determination device connected to a terminal device via a first and a second connection means, comprising: an image control unit which transmits, via the first connection means, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining unit which obtains, via the second connection means, a designated position designated on the screen of the terminal device; and a determination unit which determines whether or not the positions of the target images displayed on the screen are designated in a predetermined order.

Still another invention is a determination method executed by a determination device including a display unit, comprising: an image control process which displays, on a screen of the display unit, (i) a target image arbitrarily specifying a position on the screen in order with arbitrarily changing the position on the screen, or (ii) a plurality of target images arbitrarily specifying the positions on the screen at a same time; an obtaining process which obtains a designated position designated on the screen; and a determination process which determines whether or not the positions of the target images displayed on the screen are designated in a predetermined order.

Still another invention is a determination method executed by a determination device connected to a terminal device via a network, comprising: an image control process which transmits, via the network, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining process which obtains, via the network, a designated position designated on the screen of the terminal device; and a determination process which determines whether or not the positions of the target images displayed on the screen are designated in a predetermined order.

Still another invention is determination method executed by a determination device connected to a terminal device via a first and a second connection means, comprising: an image control process which transmits, via the first connection means, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining process which obtains, via the second connection means, a designated position designated on the screen of the terminal device; and a determination process which determines whether or not the positions of the target images displayed on the screen are designated in a predetermined order.

Still another invention is a determination program executed by a determination device including a display unit, making the determination device execute: an image control process which displays, on a screen of the display unit, (i) a target image arbitrarily specifying a position on the screen in order with arbitrarily changing the position on the screen, or (ii) a plurality of target images arbitrarily specifying the positions on the screen at a same time; an obtaining process which obtains a designated position designated on the screen; and a determination process which determines whether or not the positions of the target images displayed on the screen are designated in a predetermined order.

Still another invention is a determination program executed by a determination device connected to a terminal device via a network, making the determination device execute: an image control process which transmits, via the network, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining process which obtains, via the network, a designated position designated on the screen of the terminal device; and a determination process which determines whether or not the positions of the target images displayed on the screen are designated in a predetermined order.

Still another invention is a determination program executed by a determination device connected to a terminal device via a first and a second connection means, making the determination device execute: an image control process which transmits, via the first connection means, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining process which obtains, via the second connection means, a designated position designated on the screen of the terminal device; and a determination process which determines whether or not the positions of the target images displayed on the screen are designated in a predetermined order.

### BRIEF DESCRIPTION OF THE DRAWINGS

FIG. 1 is a block diagram illustrating a schematic configuration of a determination device according to a first embodiment.

FIG. 2 shows examples of a display screen in a determination processing.

FIG. 3 is a flowchart illustrating a determination processing according to the first embodiment.

FIG. 4 is a block diagram illustrating a schematic configuration of a determination device according to a second embodiment.

FIG. 5 is a flowchart illustrating a determination processing according to the second embodiment.

FIG. 6 is a block diagram illustrating a schematic configuration of a determination device according to a third embodiment.

FIG. 7 is a flowchart illustrating a determination processing according to the third embodiment.

FIGS. 8A to 8C show other examples of the display screen in the determination processing.

### DETAILED DESCRIPTION OF THE PREFERRED EMBODIMENTS

According to one aspect of the present invention, there is provided a determination device comprising: an image control unit which displays, on a screen, (i) a target image arbitrarily specifying a position on the screen in order with arbitrarily changing the position on the screen, or (ii) a plurality of target images arbitrarily specifying the positions on the screen at a same time; an obtaining unit which obtains a designated position designated on the screen; and a determination unit which determines whether or not the positions of the target images displayed on the screen are designated in a predetermined order.

The above determination device displays a plurality of target images arbitrarily specifying a position on a screen, and obtains a designated position by a user corresponding to the target image. Then, the determination device determines whether or not the positions of the target images displayed on the screen are designated by the user in a predetermined order. Thus, it is possible to determine whether or not an operator is a human being, in a simple and convenient way for the user.

According to another aspect of the present invention, there is provided a determination device connected to a terminal device via a network, comprising: an image control unit which transmits, via the network, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining unit which obtains, via the network, a designated position designated on the screen of the terminal device; and a determination unit which determines whether or not the positions of the target images displayed on the screen are designated in a predetermined order.

The above determination device generates a plurality of target images arbitrarily specifying a position on a screen, and transmits them via the network to be displayed on the screen of the terminal device. Then, the determination device obtains a designated position by a user corresponding to the target image via the network. Then, the determination device determines whether or not the positions of the target images displayed on the screen are designated by the user in a predetermined order. Thus, it is possible to determine whether or not an operator is a human being, in a simple and convenient way for the user.

According to still another aspect of the present invention, there is provided a determination device connected to a terminal device via a first and a second connection means, comprising: an image control unit which transmits, via the first connection means, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining unit which obtains, via the second connection means, a designated position designated on the screen of the terminal device; and a determination unit which determines whether or not the positions of the target images displayed on the screen are designated in a predetermined order.

The above determination device generates a plurality of target images arbitrarily specifying a position on a screen, and transmits them via the first connection means to be displayed on the screen of the terminal device. Also, the determination device obtains a designated position by a user corresponding to the target image via the second connection means. Then, the determination device determines whether or not the positions of the target images displayed on the screen are designated by the user in a predetermined order. Thus, it is possible to determine whether or not an operator is a human being, in a simple and convenient way for the user.

In one mode of the above determination device, the image control unit displays a target image, and displays a new target image one by one in order when the determination unit determines that the position of the target image is designated in the predetermined order, i.e., the designated position coincides with the position of the target image.

In another mode of the above determination device, the image control unit displays the plural target images at the same time, and the determination unit determines whether or not the positions of the target images displayed on the screen are designated in the predetermined order. In this case, preferably, each of the target images includes an obscure character indicating an order, and the determination unit determines whether or not the plural target images are designated in the order indicated by the obscure character.

In a preferred example, the target image has an obscure outline.

In another preferred example, the target image indicates, on the screen, a route to be traced by the user, and the route is drawn randomly.

In still another preferred example, the target image is an image of a puzzle forming a set of pieces by combining plural pieces, and shapes and a number of the plural pieces are determined randomly.

In an example preferred in any one of the embodiments, an authentication is determined to be successful if a number of coincidence, which is a number of times that the determination unit determines that the position of the target image is designated in the predetermined order, reaches a predetermined necessary number of coincidence. Also, the number of coincidence at that time is reset if a number of incoincidence, which is a number of times that the determination unit determines that the position of the target image is not designated in the predetermined order, exceeds a predetermined tolerable number of incoincidence. Thus, the accuracy of the determination may be improved.

According to still another aspect of the present invention, there is provided a determination method executed by a determination device including a display unit, comprising: an image control process which displays, on a screen of the display unit, (i) a target image arbitrarily specifying a position on the screen in order with arbitrarily changing the position on the screen, or (ii) a plurality of target images arbitrarily specifying the positions on the screen at a same time; an obtaining process which obtains a designated position designated on the screen; and a determination process which determines whether or not the positions of the target images displayed on the screen are designated in a predetermined order.

According to still another aspect of the present invention, there is provided a determination method executed by a determination device connected to a terminal device via a network, comprising: an image control process which transmits, via the network, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining process which obtains, via the network, a designated position designated on the screen of the terminal device; and a determination process which determines whether or not the positions of the target images displayed on the screen are designated in a predetermined order.

According to still another aspect of the present invention, there is provided a determination method executed by a determination device connected to a terminal device via a first and a second connection means, comprising: an image control process which transmits, via the first connection means, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining process which obtains, via the second connection means, a designated position designated on the screen of the terminal device; and a determination process which determines whether or not the positions of the target images displayed on the screen are designated in a predetermined order.

Also by the above methods, the determination can be performed in a simple and convenient way for the user.

According to still another aspect of the present invention, there is provided a determination program executed by a determination device including a display unit, making the determination device execute: an image control process which displays, on a screen of the display unit, (i) a target image arbitrarily specifying a position on the screen in order with arbitrarily changing the position on the screen, or (ii) a plurality of target images arbitrarily specifying the positions on the screen at a same time; an obtaining process which obtains a designated position designated on the screen; and a determination process which determines whether or not the positions of the target images displayed on the screen are designated in a predetermined order.

According to still another aspect of the present invention, there is provided a determination program executed by a determination device connected to a terminal device via a network, making the determination device execute: an image control process which transmits, via the network, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining process which obtains, via the network, a designated position designated on the screen of the terminal device; and a determination process which determines whether or not the positions of the target images displayed on the screen are designated in a predetermined order.

According to still another aspect of the present invention, there is provided a determination program executed by a determination device connected to a terminal device via a first and a second connection means, making the determination device execute: an image control process which transmits, via the first connection means, (i) a target image arbitrarily specifying a position on the screen in order with arbitrarily changing the position on the screen, or (ii) a plurality of target images arbitrarily specifying the positions on the screen at a same time, to be displayed on a screen of the terminal device; an obtaining process which obtains, via the second connection means, a designated position designated on the screen of the terminal device; and a determination process which determines whether or not the positions of the target images displayed on the screen are designated in a predetermined order.

Also by the above programs, the determination can be performed in a simple and convenient way for the user. The above programs may be handled in a manner stored in a storage medium.

### EMBODIMENTS

Preferred embodiments of the present invention will be described below with reference to the attached drawings.

### 1st Embodiment

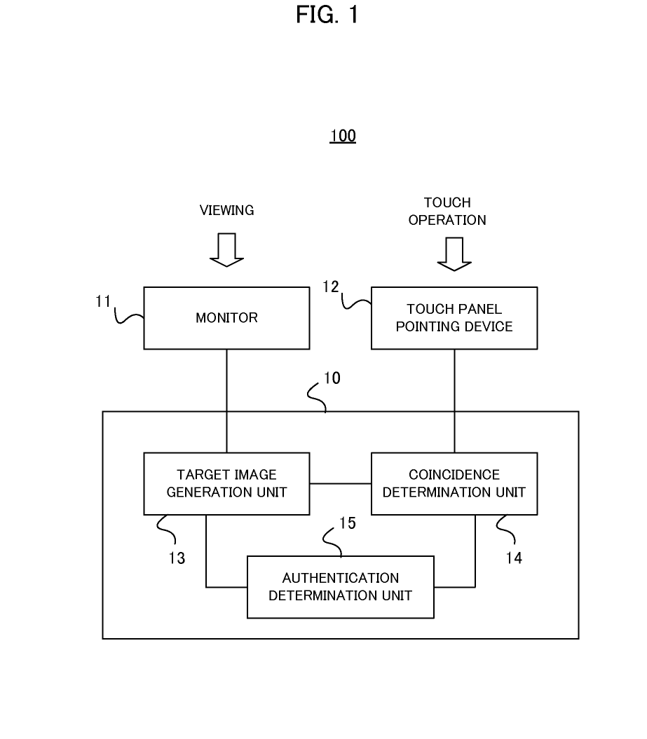

FIG. 1 shows a configuration of a determination device according to a first embodiment of the present invention. The determination device 100 includes a control unit 10, a monitor 11 and a touch panel pointing device (hereinafter simply referred to as “touch panel”) 12.

The monitor 11 is a liquid crystal display, for example, and displays information to be present to a user. The touch panel 12 is arranged to overlap with the monitor 11, and obtains X/Y coordinates of the position where the user touches on the image displayed on the monitor 11.

The control unit 10 includes a CPU, a RAM and a ROM in terms of hardware, and performs various processing by executing programs stored in the ROM. The control unit 10 includes a target image generation unit 13, a coincidence determination unit 14 and an authentication determination unit 15 in terms of its function.

The authentication determination unit 15 controls the target image generation unit 13 to generate an authentication image used for the determination processing. Here, the authentication image is an image that designates and specifies a random position on the screen of the monitor 11, and it will be hereinafter referred to as “target image”. The target image generation unit 13 outputs the generated target image to the monitor 11. In addition to the image data to be displayed as the target image, the target image generation unit 13 also generates the coordinates (hereinafter referred to as “the target position coordinates”) of the position on the monitor 11 where the target image is to be displayed, and supplies them to the monitor 11. The monitor 11 displays the target image thus inputted at the target position thus supplied. In this way, the target image is presented to the user. The target image generation unit 13 also supplies the generated target position coordinates to the coincidence determination unit 14.

The user touches the position indicated by the target image displayed on the monitor 11 by a finger, for example. The touch panel 12 overlaid on the monitor 11 detects the position touched by the user, and supplies the X/Y coordinates of the position to the coincidence determination unit 14 as the input coordinates. The coincidence determination unit 14 determines whether or not the user touched the position indicated by the target image based on the target position coordinates obtained from the target image generation unit 13 and the input coordinates obtained from the touch panel 12. Specifically, the coincidence determination unit 14 determines whether or not the target position coordinates coincide with the input coordinates. Then, the coincidence determination unit 14 sends, to the authentication determination unit 15, the determination result as to whether or not those coordinates coincide with each other.

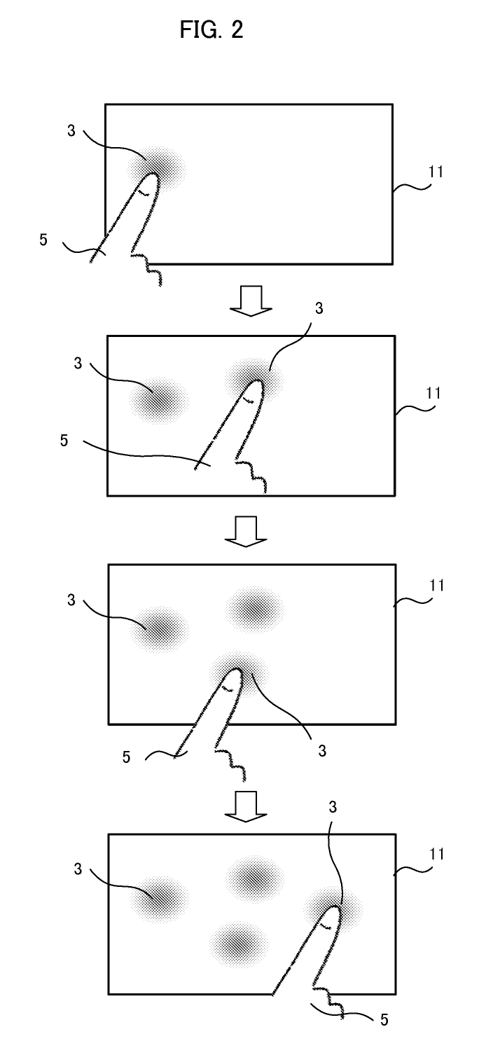

FIG. 2 shows examples of the target image displayed on the monitor 11. As shown, on the monitor 11, a mark 3 like a cloud having blurry outline is displayed as the target image. The user 5 touches the mark 3 by a finger or the like. In this example, the mark 3 has high color density at its center and has low color density at its circumference, and hence its outline is obscure. The target position coordinates are the coordinates of the area of the mark 3. Namely, the position indicated by the target image is the circular area of the mark 3. If the input coordinates by the user's touch belongs to this circular area, the coincidence determination unit 14 determines that the coordinates coincide and sets the coincidence determination result to “Coincidence”. On the other hand, if the input coordinates by the user's touch do not belong to this circular area, the coincidence determination unit 14 determines that the coordinates do not coincide and sets the coincidence determination result to “Incoincidence”. Then, the coincidence determination unit 14 supplies the coincidence determination result to the authentication determination unit 15. In the above example, since the target image indicates the circular area, the target position coordinates are the set of the coordinates of the circular area. In a case where the target position coordinates are not a point but have a certain area (expanse), if the input coordinates belong to the target position coordinates, the coincidence determination unit 14 sets the result to “Coincidence”. In the following description, a number of times that the coincidence determination unit 13 determines “Coincidence” is referred to as a “number of coincidence”, and a number of times that the coincidence determination unit 13 determines “Incoincidence” is referred to as a “number of incoincidence”.

The authentication determination unit 15 controls the target image generation unit 13 based on the coincidence termination result inputted from the coincidence determination unit 14. Specifically, every time the authentication determination unit obtains the coincidence determination result from the coincidence determination unit 14, it controls the target image generation unit 13 to generate a new target image indicating another position and to display it on the monitor 11. Then, the coincidence determination unit 14 supplies the coincidence determination result for the new target image to the authentication determination unit 15.

Then, the authentication determination unit 15 determines that the authentication is successful when it obtains the coincidence determination result of “Coincidence” for a predetermined number of times. This predetermined number of times will be referred to as a “necessary number of coincidence”. For example, in the case where the necessary number of coincidence is “4 (times)”, the authentication determination unit 15 counts up the number of coincidence every time it obtains the coincidence determination result of “Coincidence” from the coincidence determination unit 14, and determines that the authentication is successful when the number of the coincidence determination result of “Coincidence” reaches “4”.

On the other hand, when the coincidence determination result by the coincidence determination unit 14 is “Incoincidence”, the authentication determination unit 15 resets the number of coincidence until that time. Therefore, in the case where the necessary number of coincidence is “4”, the display of the target image and the coincidence determination are repeated until the coincidence determination result becomes “Coincidence” successively four times.

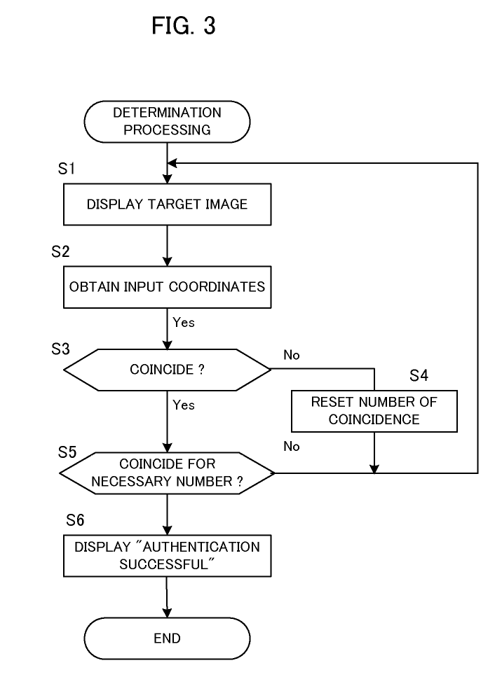

Next, the determination processing performed by the determination device 100 will be described. FIG. 3 is a flowchart of the determination processing. This processing is realized by the control unit 10 which executes a program prepared in advance. FIG. 2 shows the transition of the display screen during the determination processing.

First, the target image generation unit 13 generates the target image and displays it on the monitor 11 (step S1). Then, the coincidence determination unit 14 obtains the input coordinates which are the coordinates of the position where the user touches (step S2), and determines whether or not the input coordinates coincide with the target position coordinates obtained from the target image generation unit 13 (step S3). When the target position coordinates and the input coordinates do not coincide (step S3: No), the authentication determination unit 15 resets the number of coincidence to “0” (step S4), and then the process returns to step S1.

On the contrary, when the target position coordinates and the input coordinates coincide (step S3: Yes), the authentication determination unit 15 determines whether or not the number of coincidence until that time reaches the necessary number of coincidence (step S5). In the above example, the authentication unit 15 determines whether or not the number of coincidence until that time reaches “4”.

When the number of coincidence does not reach the necessary number of coincidence (step S5: No), the process returns to step S1. Therefore, a new target image is displayed and the coincidence is determined. On the contrary, when the number of coincidence reaches the necessary number of coincidence (step S5: Yes), the authentication determination unit 15 determines that the authentication is successful and displays it. Then, the process ends.

In this way, according to this embodiment, it is only necessary for the user to simply touch the position on the monitor where the target image indicates, and it is not necessary for the user to read the character string deliberately created to be illegible in the above-mentioned prior art. Therefore, the determination of the user can be performed by a simple method without a burden on the user.

While the necessary number of coincidence is four in the above example, the application of the present invention is not limited to this. As the necessary number of coincidence increases, the security becomes high but the burden on the user increases. Therefore, the necessary number of coincidence may be determined in consideration of the security level required.

In the above example, in steps S3 to S4, the number of coincidence until that time is reset to “0” if the coincidence determination result becomes “Incoincidence” even once. Instead, a predetermined tolerable number of incoincidence may be determined in advance, and the number of coincidence until that time may be reset if the number of incoincidence by the coincidence determination exceeds the tolerable number of incoincidence. For example, in the case where the tolerable number of incoincidence is determined to “1” (once), the number of coincidence until that time is reset to “0” if the coincidence determination results in “Incoincidence” successively twice.

In this embodiment, since the target image is generated at random positions every time, the determination cannot be successful by only mechanically touching a predetermined position on the screen. Thus, it is possible to confirm that the operator is a human being. In addition, by using the mark 3 like a cloud having obscure outline as the target image, the reading by the above-mentioned “bot” becomes difficult and the security can be improved.

In the example of FIG. 2, four target images (marks 3) are displayed eventually, and the old target image is still being displayed when the new target image is displayed. Instead, the old image may be eliminated when the new target image is displayed. For example, a target image may have such an entertainment that a firefly comes flying and stops on the screen to make the user touch the position of the firefly, and when the user touches the firefly on the screen, then it flies up again and stops on another position on the screen, making the user touch it again. In such a case, the user can perform the determination operation like playing a game without troublesome feeling.

### 2nd Embodiment

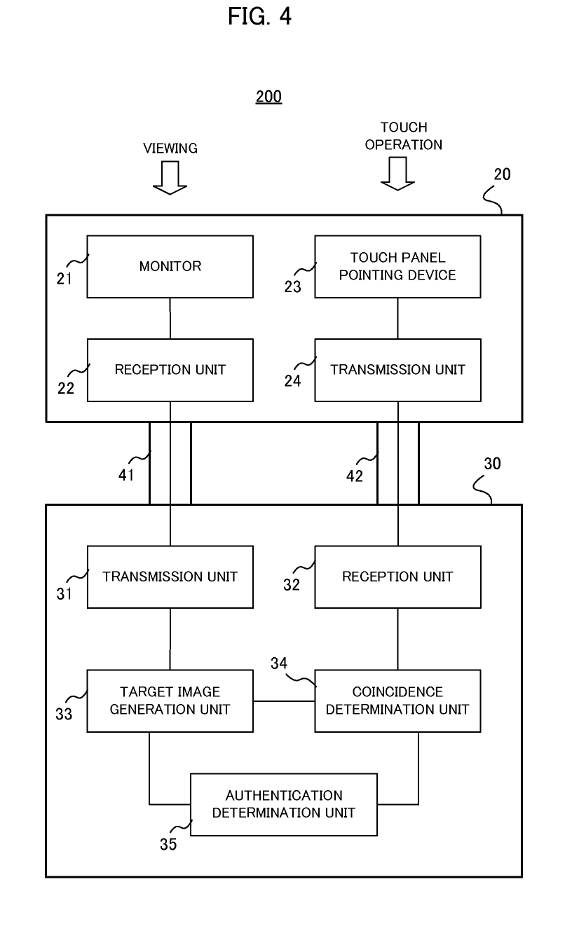

Next, the second embodiment of the present invention will be described. FIG. 4 shows a configuration of a determination device according to the second embodiment. In the first embodiment, the control unit 10, the monitor 11 and the touch panel 12 are configured in a single unit. In contrast, as illustrated, in the determination device 200 of the second embodiment, a display device 20 including a monitor 21 and a touch panel 23 and a control device 30 including an authentication determination unit 35 are separately configured.

Specifically, the display device 20 and the control device 30 are configured as an independent devices, respectively, and are communicably connected to each other via a first connection means 41 and a second connection means 42. For example, the display unit 20 may be an on-vehicle device such as a car navigation device, and the control device 30 may be a terminal device such as a smartphone. In this case, the first connection means 41 may be a HDMI (High Definition Multimedia Interface), and the second connection means 42 may be Bluetooth (Registered Trademark) or a USB cable.

The display device 20 includes a monitor 21, a reception unit 22, a touch panel 23 and a transmission unit 24. The monitor 21 and the touch panel 23 are the same as the monitor 11 and the touch panel 21 in the first embodiment, respectively.

The control device 30 includes a transmission unit 31, a reception unit 32, a target image generation unit 33, a coincidence determination unit 34 and an authentication determination unit 35. The target image generation unit 33, the coincidence determination unit 34 and the authentication determination unit 35 are the same as the target image generation unit 11, the coincidence determination unit 14 and the authentication determination unit 15 in the first embodiment, respectively.

The target image generated by the target image generation unit 33 is supplied to the transmission unit 31, and is received by the reception unit 22 in the display device 20 via the first connection means 41. The target image received by the reception unit 22 is displayed on the monitor 21 to be presented to the user. When the user touches the position of the target image displayed on the monitor 21, the touch panel 23 obtains the input coordinates and supplies them to the transmission unit 24. The transmission unit 24 transmits the input coordinates to the reception unit 32 in the control device 30 via the second connection means 42. The input coordinates received by the reception unit 32 is supplied to the coincidence determination unit 34 and is used for the coincidence determination.

As described above, while the second embodiment has such a configuration that the display device 20 and the control device 30 are connected by the two connection means 41 and 42, its function is the same as the first embodiment. Therefore, the user can perform the determination processing only by touching the target image displayed on the monitor 21 similarly to the first embodiment.

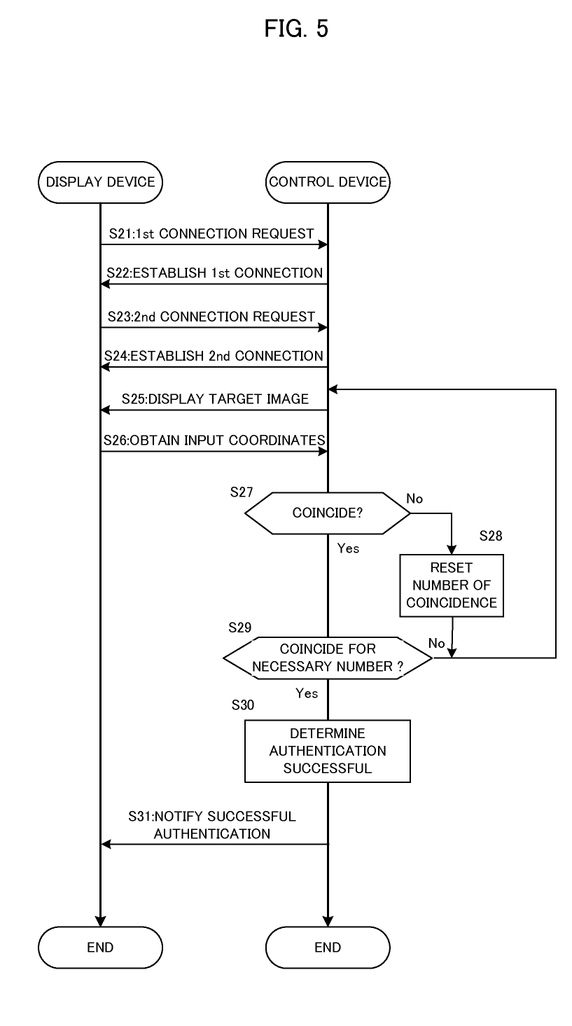

Next, the determination processing executed by the determination device 200 will be described. FIG. 5 is a flowchart of the determination processing. This processing is realized mainly by the control device 30 executing a program prepared in advance.

First, the communication is established between the display device 20 and the control device 30 via the first connection means 41 and the second connection means 42. Specifically, the transmission unit 31 of the control device 30 transmits a connection request to the reception unit 22 of the display device 20 via the first connection means 41 (step S21), and the reception unit 22 of the display unit 20 responds to the request to establish the first connection (step S22). Similarly, the reception unit 32 of the control device 30 transmits a connection request to the transmission unit 24 of the display device 20 via the second connection means 42 (step S23), and the transmission unit 24 of the display responds to the request to establish the second connection (step S24).

Next, the target image generation unit 33 generates the target image, and transmits it to the display device 20 via the first communication means 41 to make it displayed on the monitor 21 (step S25). Next, the coincidence determination unit 34 obtains the input coordinates indicating the position touched by the user from the touch panel 42 via the second communication means 42 (step S26), and determines whether or not the input coordinates coincide with the target position coordinates (step S27). When the input coordinates do not coincide with the target position coordinates (step S27: No), the authentication determination unit 35 resets the number of coincidence to “0” (step S28), and the process returns to step S25.

On the contrary, when the input coordinates coincide with the target position coordinates (step S27: Yes), the authentication determination unit 35 determines whether or not the number of coincidence until that time reaches the necessary number of coincidence (step S29).

When the number of coincidence does not reach the necessary number of coincidence (step S29: No), the process returns to step S25. On the contrary, when the number of coincidence reaches the necessary number of coincidence (step S29: Yes), the authentication determination unit 35 determines that the authentication is successful (step S30), and notifies the success of the authentication to the display device 20 (step S31). Thus, the success of the authentication is displayed on the monitor 21, and the user can know the success of the authentication. Then, the determination processing ends.

In this way, also in this embodiment, it is only necessary for the user to simply touch the position on the monitor where the target image indicates, and it is not necessary for the user to read the character string deliberately created to be illegible in the above-mentioned prior art. Therefore, the user can be determined by a simple method without a burden on the user. It is noted that how to determine the necessary number of coincidence and the tolerable number of incoincidence is the same as the first embodiment.

In this embodiment, since the target image is generated at random positions every time, the determination cannot be successful by only mechanically touching a predetermined position on the screen. Thus, it is possible to confirm that the operator is a human being. In addition, since the HDMI serving as the first connection means and the Bluetooth serving as the second communication means must be connected to the determination device and the display device at the same time when the determination operation is performed, it is possible to confirm that the determination device and the control device are appropriately connected to each other.

### 3rd Embodiment

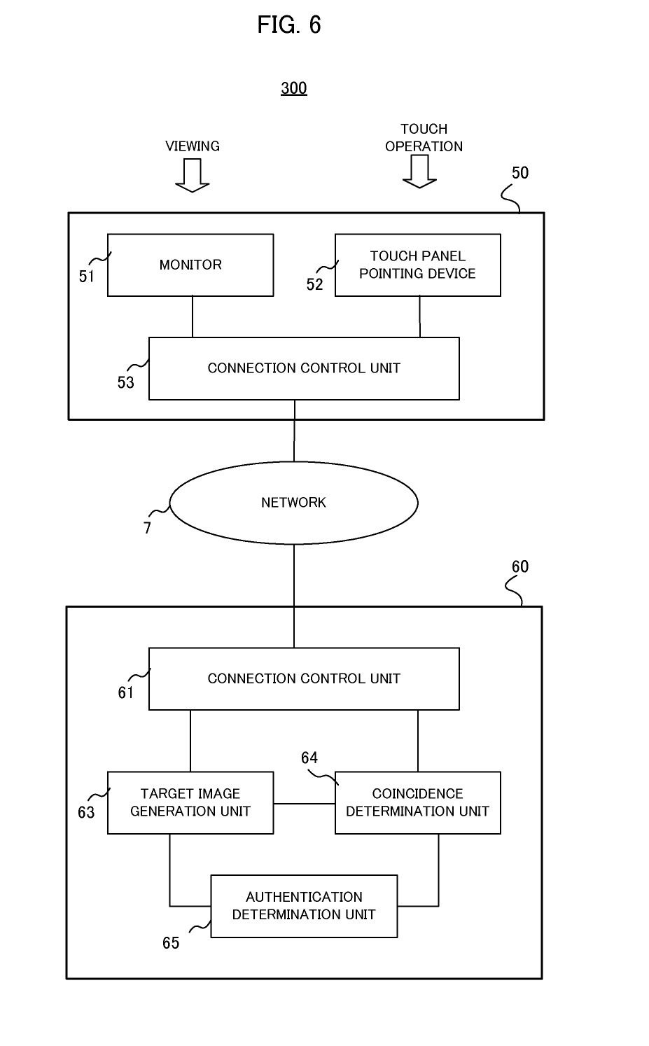

Next, the third embodiment of the present invention will be described. FIG. 6 shows a configuration of a determination device according to the third embodiment. In the first embodiment, the control unit 10, the monitor 11 and the touch panel 12 are formed as a single unit. In contrast, as illustrated, the determination device 300 according to the third embodiment includes a terminal device 50 having a monitor 51 and a touch panel 52, and a server device 60 having an authentication determination unit 65.

Specifically, the terminal device 50 and the server device 60 are communicably connected to each other via a network 7. For example, the terminal device may be a portable terminal device such as a PC and a smartphone.

The terminal device 50 includes the monitor 51, the touch panel 52 and a communication control unit 53. The monitor 51 and the touch panel 52 are the same as the monitor 11 and the touch panel 12 in the first embodiment, respectively.

The server device 60 includes a communication control unit 61, a target image generation unit 63, a coincidence determination unit 64 and an authentication determination unit 65. The target image generation unit 63, the coincidence determination unit 64 and the authentication determination unit 65 are the same as the target image generation unit 13, the coincidence determination unit 14 and the authentication determination unit 15 in the first embodiment, respectively.

The target image generated by the target image generation unit 63 is supplied to the communication control unit 61, and is received by the communication control unit 53 of the terminal device 50 via the network 7. The target image received by the communication control unit 53 is displayed on the monitor 51 to be presented to the user. When the user touches the position of the target image displayed on the monitor 51, the touch panel 52 obtains the input coordinates and supplies them to the communication control unit 53. The communication control unit 53 transmits the input coordinates to the communication control unit 61 of the server device 60 via the network 7. The input coordinates received by the communication control unit 61 is supplied to the coincidence determination unit 64 to be used for the coincidence determination.

As described above, while the third embodiment has such a configuration that the terminal device 50 and the server device 60 are communicably connected via the network 7, its function is the same as the first embodiment. Therefore, the user can perform the determination processing only by touching the target image on the monitor like the first embodiment.

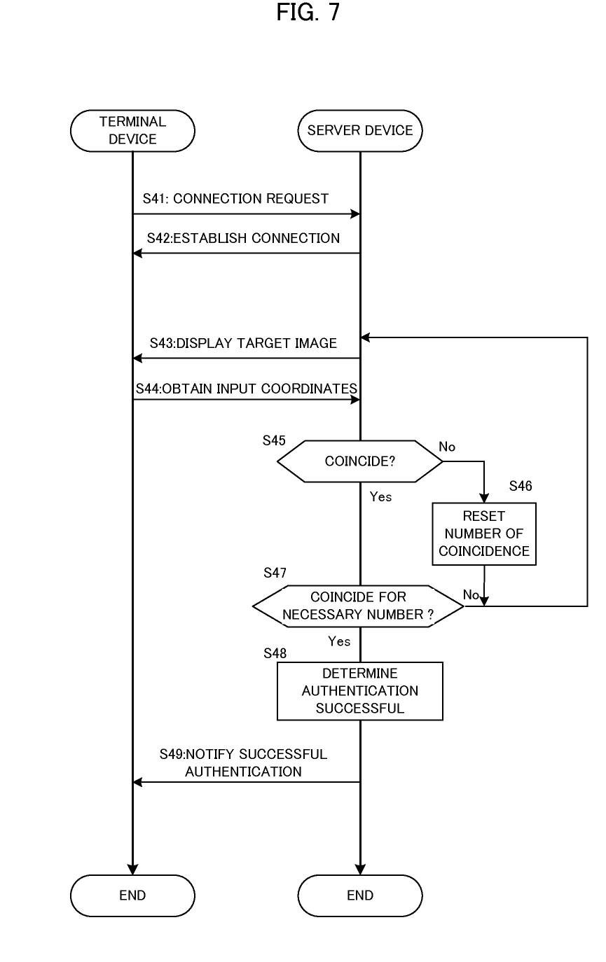

Next, the determination processing executed by the determination device 300 will be described. FIG. 7 is a flowchart of the determination processing. This processing is mainly realized by the server device 60 executing the program prepared in advance.

First, the connection via the network 7 is established between the terminal device 50 and the server device 60. Specifically, the communication control unit 53 of the terminal device 50 transmits a connection request to the communication control unit 61 of the server device 60 via the network 7 (step S41), and the communication control unit 61 of the server device 60 responds to the request. Thereby, the connection is established (step S42).

Next, the target image generation unit 63 generates the target image, and transmits it to the terminal device 20 via the network 7 to be displayed on the monitor 51 (step S43). Next, the coincidence determination unit 64 obtains the input coordinates, which are the coordinates of the position touched by the user, from the touch panel 52 via the network 7 (step S44), and determines whether or not the input coordinates coincide with the target position coordinates (step S45). When the input coordinates do not coincide with the target position coordinates (step S45: No), the authentication determination unit 65 resets the number of coincidence to “0” (step S46), and the process returns to step S43.

On the other hand, when the input coordinates coincide with the target position coordinates (step S45: Yes), the authentication determination unit 65 determines whether or not the number of coincidence until that time reaches the necessary number of coincidence (step S47).

When the number of coincidence until that time does not reach the necessary number of coincidence (step S47: No), the process returns to step S43. On the contrary, when the number of coincidence reaches the necessary number of coincidence (step S47: Yes), the authentication determination unit 65 determines that the authentication is successful (step S48), and notifies the terminal device 50 of the success of the authentication (step S49). Thus, the success of the authentication is displayed on the monitor 51, and the user can know the success of the authentication. Then, the determination processing ends.

In this way, also in this embodiment, it is only necessary for the user to simply touch the position on the monitor where the target image indicates, and it is not necessary for the user to read the character string deliberately created to be illegible in the above-mentioned prior art. Therefore, the user can be determined by a simple method without a burden on the user. It is noted that how to determine the necessary number of coincidence and the tolerable number of incoincidence is the same as the first embodiment.

### MODIFIED EXAMPLES

### Other Examples of Target Image

In the above embodiments, one target image is a mark 3 shown in FIG. 2, and the mark 3 is displayed in order until the necessary number of coincidence is achieved. Alternatively, target images (i.e., the mark 3) of a number corresponding to the necessary number of coincidence may be displayed at the same time to make the user touch the target images at the same time. In this case, the coincidence determination unit determines whether or not each of the marks 3 is touched at the same time based on the plural input coordinates, and supplies the determination results to the authentication determination unit. The authentication determination unit may obtain the coincidence determination results for the marks 3 of the number corresponding to the necessary number of coincidence, and may determine that the authentication is successful when all the determination results indicate the coincidence. In this configuration, the input time for the user may be reduced.

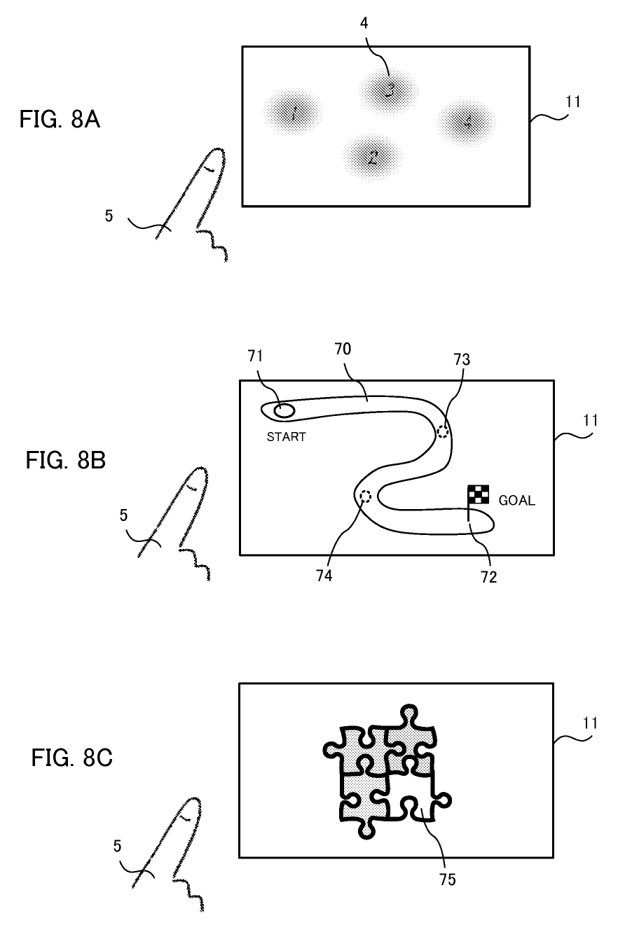

As a modified example of the case where plural target images corresponding to the necessary number of coincidence are displayed at the same time, as shown in FIG. 8A, each of the target images 4 may include a figure indicating the order for the user to touch the target image 4. Based on the input coordinates, the coincidence determination unit determines whether or not the target images are touched in a predetermined order, i.e., in the order indicated by the figures, and supplies the determination results to the authentication determination unit. The authentication determination unit determines whether or not the number of coincidence reaches the necessary number of coincidence. Then, the authentication determination unit determines that the authentication is successful if all the target images 4 are touched in a correct order. While the figures are used as the characters indicating the order in FIG. 8A, characters other than the figures may be used. For example, it is possible to use alphabets that mean something when they are arranged in the order. It is preferred that the target images 4 are made obscure by blurring its outline and also slightly blurring the characters displayed. Thus, it becomes possible to enhance the security by making the reading by the above-mentioned “bot” difficult.

FIG. 8B shows another example of the target image. This target image indicates a route 70 from a start position 71 to a goal position 72. As the target image position coordinates, in addition to the start position 71 and the goal position 72, the other positions on the route 79, e.g., the intermediate positions 73, 74 at the turning points of the route may be used. It is not necessary to display the intermediate positions 73, 74 in a manner recognizable by the user. The user performs the input to trace the route 70 by a finger on the touch panel from the start position 71 to the goal position 72. The touch panel obtains the input by the user as a set of plural input coordinates on the route 70 traced by the user. The coincidence determination unit determines whether or not the input coordinates by the user coincide with the target position coordinates, i.e., the start position 71, the intermediate positions 73, 74 and the goal position 72. When the determination results of “coincides” are obtained at those four positions, the authentication determination unit determines that the number of coincidence reaches the necessary number of coincidence and determines that the authentication is successful.

FIG. 8C shows still another example of the target image. This target image is an image of a jigsaw puzzle including plural pieces 75. In this example, the plural pieces 75 are arranged at disordered positions at first, and the user is requested to combine the pieces 75 at the center of the monitor. The user drags and moves the pieces 75 to create the state of the completed puzzle as shown in FIG. 8C. The positions of the pieces 75 in the state of FIG. 8C are the target coordinate positions. The touch panel obtains the coordinates of the pieces dragged by the user as the input coordinates, and the coincidence determination unit performs the coincidence determination by comparing the input coordinates with the target coordinate positions. When the coincidence determination results become “coincides” for all the four pieces 75, the authentication determination unit determines that the authentication is successful.

By using the authentication images having such entertainment, the user can perform the authentication operation with a feeling of playing game and without a troublesome feeling.

(Input Device)

In the above embodiments, the input device for the user is a touch panel overlaid on the monitor, but the application of the present invention is not limited to this. Instead, a mouse may be used as an input device. In that case, instead of touching on the touch panel, the user may click the position of the target image by the mouse, and the mouse may obtain the coordinates of the positions clicked by the user to supply them to the coincidence determination unit.

### INDUSTRIAL APPLICABILITY

This invention can be used for a various devices which determines that a user is a human being by utilizing a computer terminal and a portable terminal.

### DESCRIPTION OF REFERENCE NUMERALS

7 Network
11, 21, 51 Monitor
12, 23, 52 Touch Panel
13, 33, 63 Target Image Generation Unit
14, 34, 64 Coincidence Determination Unit
15, 35, 65 Authentication Determination Unit
41, 42 Connection Means

1-17. (canceled)

18. A determination method executed by a determination device including a display unit, comprising:
an image control process which displays a target image on a screen of the display unit, with arbitrarily changing a display position;
an obtaining process which obtains a designated position designated on the screen; and
a determination process which determines whether or not the positions corresponding to the target images displayed on the screen are designated in a predetermined order,
wherein the image control process displays a target image, and displays a new target image one by one in order when the determination process determines that the position of the target image is designated in the predetermined order.

19. The determination method according to claim 18, wherein the target image has an obscure outline.

20. The determination method according claim 18, further comprising an authentication determination process which determines that an authentication is successful if a number of coincidence, which is a number of times that the determination process determines that the position of the target image is designated in the predetermined order, reaches a predetermined necessary number of coincidence.

21. A determination method executed by a determination device including a display unit, comprising:
an image control process which displays a target image on a screen of the display unit, with arbitrarily changing a display position;
an obtaining process which obtains a designated position designated on the screen; and
a determination process which determines whether or not the positions corresponding to the target images displayed on the screen are designated in a predetermined order,
wherein the image control process displays plural target images at a same time,
wherein each of the target images includes an obscure character indicating the predetermined order, and
wherein the determination process determines whether or not the plural target images are designated in the predetermined order indicated by the obscure character.

22. The determination method according to claim 21, wherein the target image has an obscure outline.

23. The determination method according to claim 21, wherein the authentication determination process resets the number of coincidence at that time if a number of incoincidence, which is a number of times that the determination process determines that the position of the target image is not designated in the predetermined order, exceeds a predetermined tolerable number of incoincidence.

24. A determination method executed by a determination device including a display unit, comprising:
an image control process which displays a target image on a screen of the display unit;
an obtaining process which obtains a designated position designated on the screen; and
a determination process which determines whether or not the positions corresponding to the target images displayed on the screen are designated in a predetermined order,
wherein the image control process displays, as the target image, an image of a route including plural arbitrary positions in the predetermined order on the route, and
wherein the determination process determines whether or not the plural positions included in the target image are designated in the predetermined order on the route.
